(19) United States
(12) Patent Application Publication
(10) Pub. No.: US 2011/0146653 A1
(43) Pub. Date: Jun. 23, 2011

(54) COOKING DEVICE

(76) Inventor: Kazuya Kitatani, Osaka (JP)

(21) Appl. No.: 13/057,969

(22) PCT Filed: Jul. 31, 2009
(86) PCT No.: PCT/JP2009/063642

§ 371 Date: Feb. 7, 2011

(30) Foreign Application Priority Data
Aug. 8, 2008 (JP) 2008-205182

(51) Int. Cl. A21B 1/00

(52) U.S. Cl. 126/19 R

(57) ABSTRACT

Disclosed is a heating cooker (1) comprising a cooking chamber (12), a tray (13) inserted into the cooking chamber (12) in order to partition the cooking chamber inside into an upper space (12U) and a lower space (12D), an upper heater (14U) for heating the upper space (12U), a lower heater (14D) for heating the lower space (12D), an upper heater control device (21U) for controlling the output of the upper heater (14U), and a lower heater control device (21D) for controlling the output of the lower heater (14D). An upper heater temperature sensor (15U) is arranged in the upper space (12U), and a lower heater temperature sensor (15D) is disposed in the lower space (12D). A tray temperature sensor (15T) is disposed adjacent to the tray (13). A heater control device (21) including the upper heater control device (21U) and the lower heater control device (21D) controls the outputs of the upper heater (14U) and the lower heater (14D) so that the temperature of the tray (13) does not reach the smoke or firing temperature of fat and oil having stuck to the surface thereof.

### TECHNICAL FIELD

The present invention relates to a cooking device.

### BACKGROUND ART

Cooking devices that have a cooking chamber to put food in and that cook food by raising the temperature inside the cooking chamber, that is, cooking devices of the grill (broiler) type, have conventionally been in wide use. An example is seen in Patent Document 1 listed below.

The cooking device disclosed in Patent Document 1 has a grill housing, inside which a grill pan is removably placed. In the grill pan, a grill plate to put food on is placed. Above the grill plate, a heat source is disposed. The food is heated by the heat radiated from the heat source above and by the hot air inside the grill housing.

### LIST OF CITATIONS

### Patent Literature

Patent Document 1: JP-A-2000-60741

### SUMMARY OF THE INVENTION

### Technical Problem

In the cooking device disclosed in Patent Document 1, the sole heat source is disposed above food; thus, while the upper part of the food becomes hot quickly, the lower part does gently. Consequently, the food is broiled unevenly in its upper and lower parts. To overcome this inconvenience, an object of the present invention is to reduce difference in how food is broiled on its different faces, and thereby to improve cooking quality.

### Solution to Problem

To achieve the above object, according to the invention, a cooking device includes: a cooking chamber; a tray loaded in the cooking chamber; an upper heater disposed above the tray; a lower heater disposed below the tray; and a heater controller that controls the outputs of the upper and lower heaters. Here, the heater controller controls the outputs of the upper and lower heaters so that the temperature of the tray does not reach the fuming or igniting temperature of fat stuck to the surface of the tray.

With this configuration, the juices and fat exuding from food are collected in the tray so as not to soil the heater below, and this makes cleaning after cooking easy. Moreover, the lower part of the tray is heated by the lower heater; thus, the food is heated from below as well, and this reduces difference in how the food is broiled on its upper and lower faces. Moreover, the outputs of the upper and lower heaters are so controlled that the temperature of the tray does not reach the fuming or igniting temperature of the fat stuck on its surface; thus, the food is not engulfed in fumes, and no fume substances stick to the surface of the food. Thus, the food does not become sooty, and cooking quality is not spoilt visually either. Nor is the taste of the food spoilt. There is no fear of fuming or ignition making the user uneasy, and the kitchen and the ventilation duct are soiled less.

In the cooking device configured as described above, preferably, the tray partitions the cooking chamber into an upper space and a lower space.

Partitioning the cooking chamber helps reduce the influence of the amount of food in the lower space of the cooking chamber. This makes the control of the tray temperature easy, and helps further reduce the likelihood of fuming and ignition.

In the cooking device configured as described above, preferably, while the upper and lower heaters are both being operated, when the temperature of the tray or the temperature in proximity to the tray exceeds a predetermined temperature, or when the rising rate of the temperature of the tray or the rising rate of the temperature in proximity to the tray exceeds a predetermined rate, the heater controller first lowers the output of the lower heater before lowering the output of the upper heater.

With this configuration, when the temperature of, or in proximity to, the tray becomes close to the fuming temperature, or when the amount of thermal load of the article being heated is small and the temperature rises steeply, the output of the lower heater is lowered first. Thus, it is possible to suppress fuming while maintaining the heating of the surface of the article being heated.

In the cooking device configured as described above, preferably, while the output of the lower heater is equal to or lower than a predetermined output, when the temperature of the tray or the temperature in proximity to the tray exceeds a predetermined temperature, or when the rising rate of the temperature of the tray or the rising rate of the temperature in proximity to the tray exceeds a predetermined rate, the heater controller lowers the output of the upper heater.

With this configuration, it is possible to further suppress fuming. Moreover, as compared with when the outputs of the upper and lower heaters are lowered simultaneously, it is possible to shorten the time required to brown the surface of the article being heated, and thus to shorten the cooking time.

In the cooking device configured as described above, preferably, when an article to be heated is put on the tray, and the upper and lower heaters are operated, the amount of thermal load is recognized based on the value of a temperature rising rate determined from the temperature inside the cooking chamber as measured by a temperature sensor, and the recognized amount of thermal load is reflected in the control of the heaters.

With this configuration, for the purpose of suppressing the fuming of fat, the amount of thermal load of the article being heated is recognized from the temperature rising rate, and based on that, the heater outputs are controlled. This makes the control of the heater outputs easy and sure.

In the cooking device configured as described above, preferably, the upper heater is disposed inside an upper duct that is provided so as to abut on the cooking chamber.

With this configuration, it is possible to prevent the fat splashing from the food or the tray from sticking to the upper heater and causing fuming and ignition.

In the cooking device configured as described above, preferably, the lower heater is disposed inside a lower duct that is provided so as to abut on the cooking chamber.

With this configuration, it is possible to prevent the fat dripping from the tray from sticking to the lower heater and causing fuming and ignition.

In the cooking device configured as described above, preferably, an upper heater temperature sensor is disposed in the upper duct.

With this configuration, it is possible to prevent the fat splashing from the food or the tray from sticking to the upper heater temperature sensor and causing an error in temperature measurement. In addition, the temperature in the upper duct is then less influenced by the amount of food, and this makes uniform temperature control possible.

In the cooking device configured as described above, preferably, a lower heater temperature sensor is disposed in the lower duct.

With this configuration, it is possible to prevent the fat dripping from the tray from sticking to the lower heater temperature sensor and causing an error in temperature measurement. In addition, the temperature in the lower duct is then less influenced by the amount of food, and this makes uniform temperature control possible.

In the cooking device configured as described above, preferably, a steam blow outlet is formed in a top plate partitioning the upper duct from the cooking chamber, and steam is introduced into the upper duct.

With this configuration, when cooking involves simultaneous use of steam, the cooking chamber is filled with, not low-temperature steam, but steam that has been heated in the upper duct to become superheated steam. This makes efficient cooking possible.

In the cooking device configured as described above, preferably, a steam blow outlet is formed in a bottom plate partitioning the lower duct from the cooking chamber, and steam is introduced into the lower duct.

With this configuration, when cooking involves simultaneous use of steam, the cooking chamber is filled with, not low-temperature steam, but steam that has been heated in the lower duct to become superheated steam. This makes efficient cooking possible.

In the cooking device configured as described above, preferably, the tray is disposed with such an inclination as to be increasingly low frontward.

With this configuration, the juices and fat exuding from the food run frontward across the tray and thus quickly leave the food. Thus, it is possible to prevent juices and fat from being reabsorbed into the food to spoil its taste. As a result of juices and fat collecting in a front part of the tray 13, it is also easy to clean the tray.

In the cooking device configured as described above, preferably, a plurality of grooves are formed in the surface of the tray.

With this configuration, the juices and fat exuding from the food drip into the grooves, and do not touch the food. Thus, it is possible to prevent juices and fat from being reabsorbed into the food to spoil its taste.

### Advantageous Effects of the Invention

According to the present invention, the juices and fat exuding from food is collected in the tray so as not to soil the inside of the cooking chamber heavily, and this makes cleaning after cooking easy. Moreover, the upper part of the tray is heated by the upper heater, and the lower part of the tray is heated by the lower heater; thus, the food is heated from both above and below, and this reduces difference in how the food is broiled on its upper and lower faces. In addition, the outputs of the upper and lower heaters are controlled in such a way that the temperature is not reached at which the fat stuck on the surface of the tray starts to fume or ignite. This prevents fume substances from sticking to the surface of the food and degrading cooking quality. There is no fear of fuming or ignition making the user uneasy, and the kitchen and the ventilation duct are soiled less.

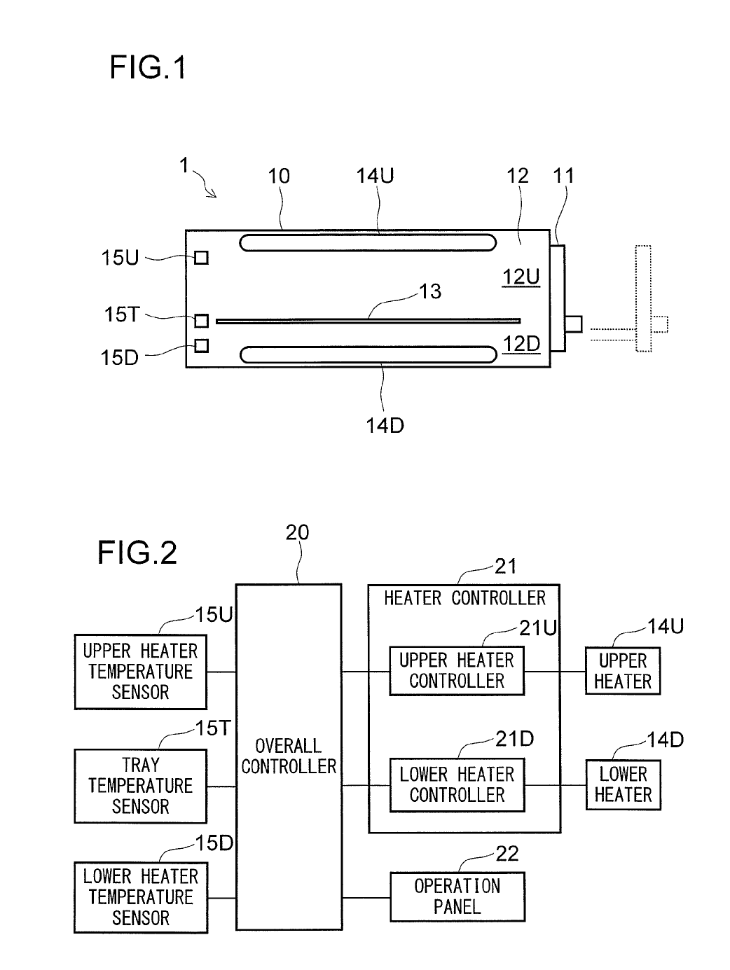

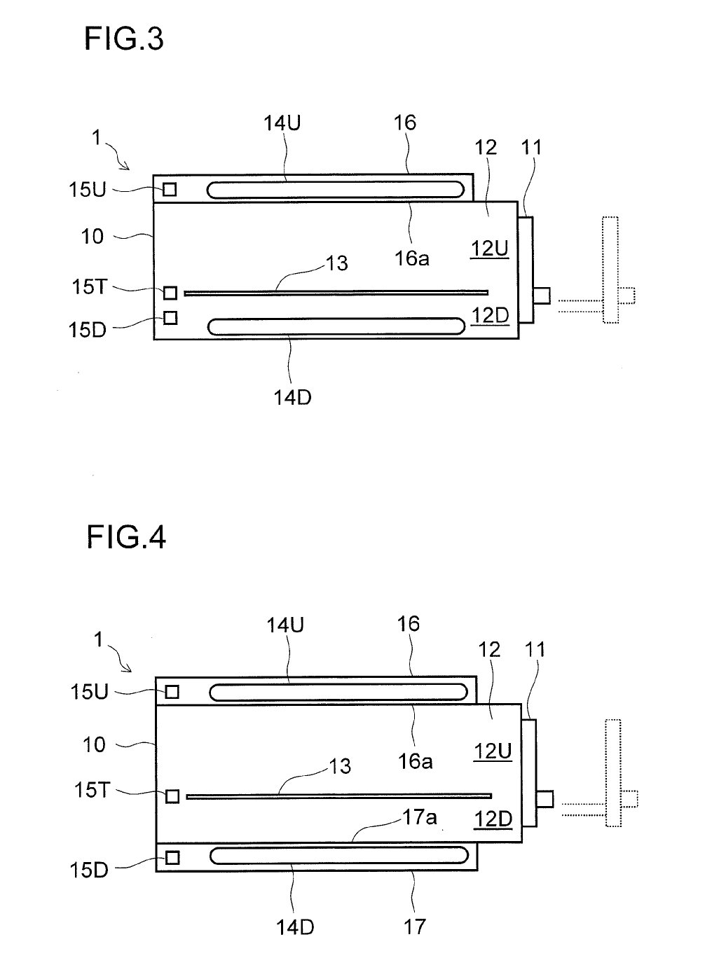

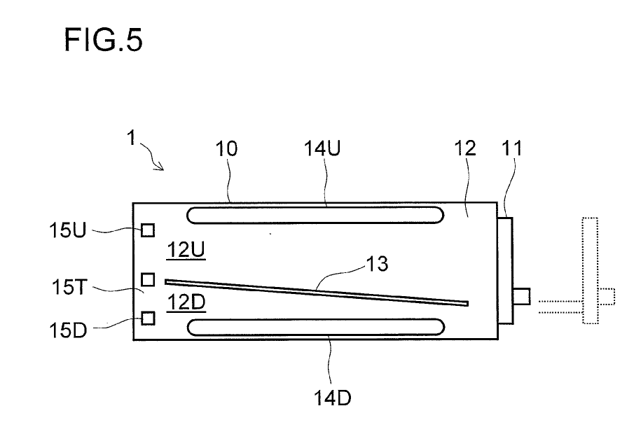

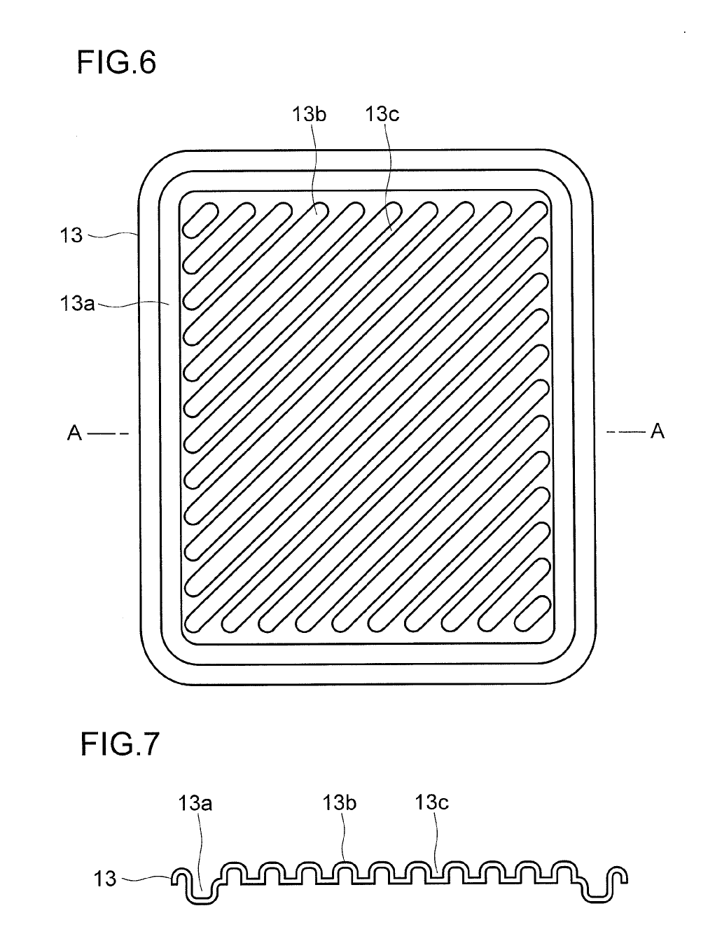

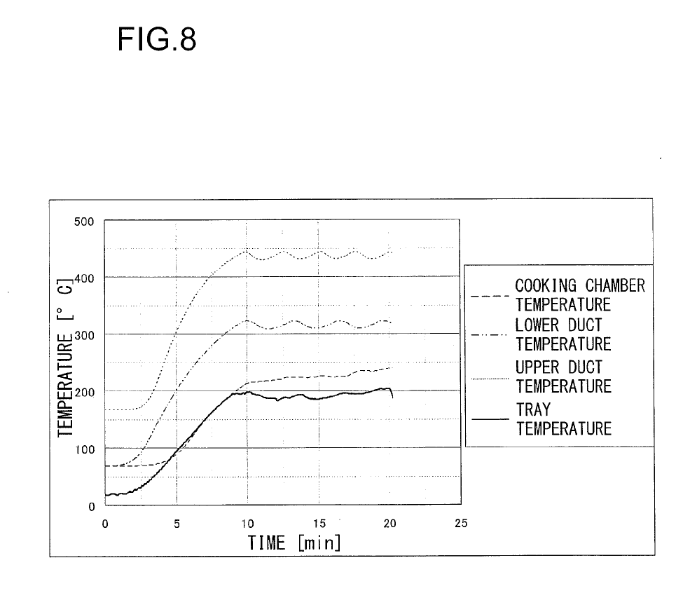

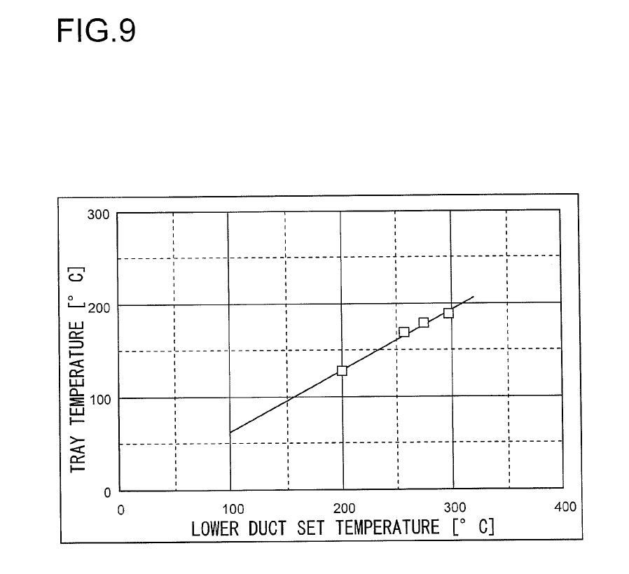

### BRIEF DESCRIPTION OF DRAWINGS

[FIG. 1] is a schematic configuration diagram of a cooking device according to a first embodiment of the invention.

[FIG. 2] is a block configuration diagram of the cooking device according to the first embodiment.

[FIG. 3] is a schematic configuration diagram of a cooking device according to a second embodiment of the invention.

[FIG. 4] is a schematic configuration diagram of a cooking device according to a third embodiment of the invention.

[FIG. 5] is a schematic configuration diagram of a cooking device according to a fourth embodiment of the invention.

[FIG. 6] is a plan view of a tray according to a fifth embodiment of the invention.

[FIG. 7] is a sectional view of the tray according to the fifth embodiment.

[FIG. 8] is a graph showing temperatures actually measured inside a cooking device.

[FIG. 9] is a graph showing the correlation between the lower duct temperature and the tray temperature in a cooking device.

### DESCRIPTION OF EMBODIMENTS

A first embodiment of the invention will be described below with reference to FIGS. 1 and 2. A cooking device 1 is of a built-in type for incorporation in a kitchen cooker unit, and has a box-shaped cabinet 10. The cabinet 10 has an opening at its front face, and the opening is shut with a drawer-type door 11.

The inside of the cabinet 10 serves as a cooking chamber 12. In the cooking chamber 12, a tray 13 to put food on is loaded. The tray 13 moves together with the door 11, and is thereby put into and taken out of the cooking chamber 12. The inside of the cooking chamber 12 is partitioned by the tray 13 into an upper space 12U and a lower space 12D.

In the upper space 12U, an upper heater 14U is disposed; in the lower space 12D, a lower heater 14D is disposed. The upper and lower heaters 14U and 14D are both sheathed heaters.

In the upper space 12U, an upper heater temperature sensor 15U is disposed; in the lower space 12D, a lower heater temperature sensor 15D is disposed. In proximity to the tray 13, a tray temperature sensor 15T is disposed.

The cooking device 1 has a control system as shown in FIG. 2. Specifically, it has an overall controller 20 which assumes overall control, and this cooperates with a heater controller 21 and an operation panel 22. The heater controller 21 includes an upper heater controller 21U and a lower heater controller 21D. The overall controller 20 receives signals from the upper heater temperature sensor 15U, lower heater temperature sensor 15D, and tray temperature sensor 15T, and based on these signals controls the heater controller 21. In the heater controller 21, the upper heater controller 21U controls the output of the upper heater 14U, and the lower heater controller 21D controls the output of the lower heater 14D.

The cooking device 1 operates in the following manner. The user opens the door 11, draws out the tray 13, and puts food on the tray 13. The user then shuts the door 11, and operates the operation panel 22 to start cooking. Now, the upper and lower heaters 14U and 14D are energized with electric current, and start to heat the upper and lower spaces 12U an 12D respectively.

At first, the upper and lower heaters 14U and 14D are both operated at their respective full powers. For example, the outputs of the upper and lower heaters 14U and 14D are set for 950 W and 650 W respectively.

The overall controller 20 receives signals from the upper heater temperature sensor 15U, lower heater temperature sensor 15D, and tray temperature sensor 15T, and by integrating these temperature information determines the actual temperature of, or in proximity to, the tray 13. So that the temperature of, or in proximity to, the tray 13 may not reach the fuming or igniting temperature of the fat exuding from food and sticking to the surface of the tray 13, the overall controller 20 instructs the heater controller 21 to control the outputs of the upper and lower heaters 14U and 14D.

While the upper and lower heaters 14U and 14D are both being operated, when the temperature of, or in proximity to, the tray 13 has exceeded a predetermined temperature, or when the rising rate of the temperature of, or in proximity to, the tray 13 has exceeded a predetermined rate, the heater controller 21 first lowers the output of the lower heater 14D before lowering that of the upper heater 14U. Thus, the output of the upper heater 14U is left as it is for the time being. If the reduction in the output of the lower heater 14D succeeds in preventing the temperature of the tray 13 from reaching the fuming or igniting temperature of fat, the output of the upper heater 14U is kept unchanged.

While the output of the lower heater 14D is equal to or lower than a predetermined output, when the temperature of, or in proximity to, the tray 13 has exceeded a predetermined temperature (set significantly lower than the fuming or igniting temperature of fat), the heater controller 21 lowers the output of the upper heater 14U. It thus prevents the temperature of the tray 13 from reaching the fuming or igniting temperature of fat.

Also, while the output of the lower heater 14D is equal to or lower than a predetermined output, when the rising rate of the temperature of, or in proximity to, the tray 13 has exceeded a predetermined rate (this means that the amount of thermal load of the article being heated is small, causing a steep rise in temperature), the heater controller 21 lowers the output of the upper heater 14U. It thus prevents the temperature of the tray 13 from reaching the fuming or igniting temperature of fat.

In this way, first, the output of the lower heater 14D alone is controlled to adjust the temperature of the tray 13; if even then the temperature cannot be adjusted sufficiently, the output of the upper heater 14U is lowered. Thus, the upper heater 14U remains operating at its full output longer, permitting food to be browned sufficiently. In other words, it is possible to suppress fuming while maintaining the heating of the surface of the article being heated.

While the output of the lower heater 14D is equal to or lower than a predetermined output, when the temperature of, or in proximity to, the tray 13 has exceeded a predetermined temperature, or when the rising rate of the temperature of, or in proximity to, the tray 13 has exceeded a predetermined rate, the heater controller 21 lowers the output of the upper heater 14U.

With this control, it is possible to further suppress fuming. Moreover, as compared with when the outputs of the upper and lower heaters 14U and 14D are lowered simultaneously, it is possible to shorten the time required to brown the surface of the article being heated, and thus to shorten the cooking time.

When an article to be heated is put on the tray 13, and the upper and lower heaters 14U and 14D are operated under predetermined conditions, the overall controller 20 recognizes the amount of thermal load on the basis of the value of a temperature rising rate determined from the temperatures inside the cooking chamber 12 measured by the temperature sensors (the upper heater temperature sensor 15U, lower heater temperature sensor 15D, and tray temperature sensor 15T), and reflects the recognized amount of thermal load in the control of the heaters. Specifically, when the amount of thermal load (which largely depends on the mass) of the article being heated is large, the overall controller 20 instructs the heater controller 21 to operate the upper and lower heaters 14U and 14D at their maximum outputs; when the amount of thermal load of the article being heated is small, the overall controller 20 instructs the heater controller 21 to operate the upper and lower heaters 14U and 14D at reduced outputs.

With this control, the amount of thermal load of the article being heated is recognized from the temperature rising rate, and based on the recognized amount of thermal load, the outputs of the heaters are controlled. This makes it easy and sure the control of the heater outputs for suppression of the fuming of fat.

Since the lower space 12D is heated by the lower heater 14D, the food is heated from below as well, and this reduces difference in how the food is broiled on its upper and lower faces. The juices and fat exuding from the food are collected in the tray 13 so as not to soil the lower heater 14D, and this makes cleaning after cooking easy.

Cooking proceeds while the outputs of the upper and lower heaters 14U and 14D are so controlled that the temperature of the tray 13 does not reach the fuming or igniting temperature of the fat stuck to its surface. This prevents the food from being engulfed in fumes, and prevents fume substances from sticking to the surface of the food. Thus, the food does not become sooty, and cooking quality is not spoilt visually either. Nor is the taste of the food spoilt. There is no fear of fuming or ignition making the user uneasy, and the kitchen and the ventilation duct are soiled less.

A second embodiment of the invention is shown in FIG. 3. In the second embodiment, over the ceiling of the cooking chamber 12, an upper duct 16 is provided as a chamber separate from but abutting on the cooking chamber 12. Inside the upper duct 16, the upper heater 14U and the upper heater temperature sensor 15U are disposed. The cooking chamber 12 and the upper duct 16 are partitioned from each other by a top plate 16a, which is a plate of a metal with good thermal conductivity. With this configuration, even when fat splashes up from the food or the tray 13, it sticks only to the top plate 16a and not to the upper heater 14U or the upper heater temperature sensor 15U. Thus, it is possible to prevent fat from being heated on the surface of the upper heater 14U and causing fuming or ignition, and to prevent the fat stuck to the upper heater temperature sensor 15U from causing an error in the temperature it measures. It is also easy to clean the cooking chamber 12, and the upper space 12U in particular.

A plurality of small holes may additionally be formed in the top plate 16a to serve as a steam blow outlet so that steam (saturated steam) is introduced into the upper duct 16 to be heated by the upper heater 14U to become superheated steam which is then blown into the cooking chamber 12 through the steam blow outlet. In this way, it is possible to fill the cooking chamber 12 with superheated steam for efficient cooking.

A third embodiment of the invention is shown in FIG. 4. As compared with the second embodiment, the third embodiment is further characterized as follows: under the floor of the cooking chamber 12, a lower duct 17 is provided as a chamber separate from but abutting on the cooking chamber 12. Inside the lower duct 17, the lower heater 14L and the lower heater temperature sensor 15L are disposed. The cooking chamber 12 and the lower duct 17 are partitioned from each other by a bottom plate 17a, which is a plate of a metal with good thermal conductivity. With this configuration, even when fat drips out of the tray 13, it sticks only to the bottom plate 17a and not to the lower heater 14D or the lower heater temperature sensor 15D. Thus, it is possible to prevent fat from being heated on the surface of the lower heater 14L and causing fuming or ignition, and to prevent the fat stuck to the lower heater temperature sensor 15D from causing an error in the temperature it measures. It is also easy to clean the cooking chamber 12, and the lower space 12D in particular.

A plurality of small holes may additionally be formed in the bottom plate 17a to serve as a steam blow outlet so that steam (saturated steam) is introduced into the lower duct 17 to be heated by the lower heater 14L to become superheated steam which is then blown into the cooking chamber 12 through the steam blow outlet. In this way, it is possible to fill the cooking chamber 12 with superheated steam for efficient cooking.

A fourth embodiment of the invention is shown in FIG. 5. The fourth embodiment is a version of the first embodiment modified as follows: the tray 13 is disposed with such an inclination as to be increasingly low frontward (toward the door 11). With this configuration, the juices and fat exuding from the food run frontward across the tray 13 and thus quickly leave the food. Thus, it is possible to prevent juices and fat from being reabsorbed into the food to spoil its taste. As a result of juices and fat collecting in a front part of the tray 13, it is also easy to clean the tray 13.

The configuration with the tray 13 inclined increasingly low frontward may be adopted in the second or third embodiment.

A fifth embodiment of the invention is shown in FIGS. 6 and 7. In the fifth embodiment, the tray 13 is ingeniously shaped. Specifically, slightly inward of the edge around the tray 13, a groove 13a is formed that describes a rectangular loop as seen in a plan view. And on the land surrounded by the groove 13a, a plurality of ridges 13b extending obliquely, at an angle of 45° (degrees), are formed at predetermined intervals. The gaps between the ridges 13b form grooves 13c extending obliquely, at an angle of 45°, and thus the tray 13 has a plurality of grooves 13c in its surface. The tray 13 shaped as described above is formed by pressing a blank sheet of an aluminum alloy or the like.

When food is put on the tray 13, the food is supported on the ridges 13b. The juices and fat exuding from the food drip into the grooves 13c, and do not touch the food. Thus, it is possible to prevent juices and fat from being reabsorbed into the food to spoil its taste.

The tray 13 of the fifth embodiment may be adopted in any of the first to fourth embodiments. When it is adopted in the fourth embodiment, the grooves 13c are higher at one ends and lower at the other ends; thus, the juices and fat that have dripped into the grooves 13c quickly run toward the lower parts, and this further reduces the likelihood of their being reabsorbed into the food. The tray 13 may be disposed front side back, because then also the grooves 13c have the same slope, with no change in how they work.

Plots of temperatures actually measured inside (the cooking chamber of) the cooking device are shown in FIGS. 8 and 9. Here, the cooking device was one according to the third embodiment, and the food was five fish, specifically Pacific sauries, which were put on the tray and broiled.

The cooking time was set for 20 minutes, the temperature in the upper duct was set for 440° C. (degrees Celsius), and the temperature in the lower duct was set for 318° C. As shown in FIG. 8, the temperature of the tray reached about 200° C. in ten minutes after the start of heating, and remained at that temperature thereafter.

FIG. 9 is a graph showing the correlation between the lower duct set temperature and the tray temperature. There, it is seen that the lower duct temperature and the tray temperature are in a proportional relationship.

It should be understood that the embodiments specifically described above are in no way meant to limit the scope of the present invention; in implementing the invention, many modifications and variations are possible without departing from its spirit.

### INDUSTRIAL APPLICABILITY

The present invention finds wide application in cooking devices.

### LIST OF REFERENCE SIGNS

1 cooking device
10 cabinet
11 door
12 cooking chamber
12U upper space
12D lower space
13 tray
13c grooves
14U upper heater
14D lower heater
15U upper heater temperature sensor
15D lower heater temperature sensor
15T tray temperature sensor
16 upper duct
17 lower duct
20 overall controller
21 heater controller
21U upper heater controller
21D lower heater controller

1. A cooking device comprising:
a cooking chamber;
a tray inserted into the cooking chamber;
an upper heater disposed above the tray;
a lower heater disposed below the tray; and
a heater controller that controls the outputs of the upper and lower heaters,
wherein the heater controller controls the outputs of the upper and lower heaters so that the temperature of the tray does not reach the fuming or igniting temperature of fat stuck to the surface of the tray.

2. The cooking device according to claim 1,
wherein the tray partitions the cooking chamber into an upper space and a lower space.

3. The cooking device according to claim 1, wherein
while the upper and lower heaters are both being operated,
when the temperature of, or in proximity to, the tray exceeds a predetermined temperature, or
when the rising rate of the temperature of, or in proximity to, the tray exceeds a predetermined rate,
the heater controller first lowers the output of the lower heater before lowering the output of the upper heater.

4. The cooking device according to claim 3, wherein
while the output of the lower heater is equal to or lower than a predetermined output,
when the temperature of, or in proximity to, the tray exceeds a predetermined temperature, or
when the rising rate of the temperature of, or in proximity to, the tray exceeds a predetermined rate,
the heater controller lowers the output of the upper heater.

5. The cooking device according to claim 1, wherein
when an article to be heated is put on the tray, and the upper and lower heaters are operated,
the amount of thermal load is recognized based on the value of a temperature rising rate determined from the temperature inside the cooking chamber as measured by a temperature sensor, and the recognized amount thermal of load is reflected in the control of the heaters.

6. The cooking device according to claim 1,
wherein the upper heater is disposed inside an upper duct that is provided so as to abut on the cooking chamber.

7. The cooking device according to claim 1,
wherein the lower heater is disposed inside a lower duct that is provided so as to abut on the cooking chamber.

8. The cooking device according to claim 6,
wherein an upper heater temperature sensor is disposed in the upper duct.

9. The cooking device according to claim 7,
wherein a lower heater temperature sensor is disposed in the lower duct.

10. The cooking device according to claim 6,
wherein a steam blow outlet is formed in a top plate partitioning the upper duct from the cooking chamber, and steam is introduced into the upper duct.

11. The cooking device according to claim 7,
wherein a steam blow outlet is formed in a bottom plate partitioning the lower duct from the cooking chamber, and steam is introduced into the lower duct.

12. The cooking device according to claim 1,
wherein the tray is disposed with such an inclination as to be increasingly low frontward.

13. The cooking device according to claim 1,
wherein a plurality of grooves are formed in a surface of the tray.

14. The cooking device according to claim 2,
wherein the tray is disposed with such an inclination as to be increasingly low frontward.

15. The cooking device according to claim 3,
wherein the tray is disposed with such an inclination as to be increasingly low frontward.

16. The cooking device according to claim 4,
wherein the tray is disposed with such an inclination as to be increasingly low frontward.

17. The cooking device according to claim 5,
wherein the tray is disposed with such an inclination as to be increasingly low frontward.

18. The cooking device according to claim 6,
wherein the tray is disposed with such an inclination as to be increasingly low frontward.

19. The cooking device according to claim 7,
wherein the tray is disposed with such an inclination as to be increasingly low frontward.

20. The cooking device according to claim 8,
wherein the tray is disposed with such an inclination as to be increasingly low frontward.

21. The cooking device according to claim 9,
wherein the tray is disposed with such an inclination as to be increasingly low frontward.

22. The cooking device according to claim 10,
wherein the tray is disposed with such an inclination as to be increasingly low frontward.

23. The cooking device according to claim 11,
wherein the tray is disposed with such an inclination as to be increasingly low frontward.

24. The cooking device according to claim 2,
wherein a plurality of grooves are formed in a surface of the tray.

25. The cooking device according to claim 3,
wherein a plurality of grooves are formed in a surface of the tray.

26. The cooking device according to claim 4,
wherein a plurality of grooves are formed in a surface of the tray.

27. The cooking device according to claim 5,
wherein a plurality of grooves are formed in a surface of the tray.

28. The cooking device according to claim 6,
wherein a plurality of grooves are formed in a surface of the tray.

29. The cooking device according to claim 7,
wherein a plurality of grooves are formed in a surface of the tray.

30. The cooking device according to claim 8,
wherein a plurality of grooves are formed in a surface of the tray.

31. The cooking device according to claim 9,
wherein a plurality of grooves are formed in a surface of the tray.

32. The cooking device according to claim 10,
wherein a plurality of grooves are formed in a surface of the tray.

33. The cooking device according to claim 11,
wherein a plurality of grooves are formed in a surface of the tray.
